(19) United States
(12) Patent Application Publication
(10) Pub. No.: US 2006/0149699 A1
(43) Pub. Date: Jul. 6, 2006

(54) Automated space usage benchmarking for institutions

(76) Inventors: James H. Wolfston, West Linn, OR (US); Andrew Heydon, Portland, OR (US); Elizabeth Bothwell, Portland, OR (US); Steven Fulmer, Portland, OR (US); Thomas Hier, Washington, DC (US)

Correspondence Address: IPSOLON LLP, #2740, 805 SW Broadway, Portland, OR, 97205, US

(21) Appl. No.: 11/233,552

(22) Filed: Sep. 22, 2005

Related U.S. Application Data
(63) Continuation of application No. 10/828,512, filed on Apr. 19, 2004, now abandoned.
(63) Continuation of application No. 11/026,607, filed on Dec. 30, 2004.

(51) Int. Cl. G06F 17/30; G06F 7/00

(52) U.S. Cl. 707/1

(57) ABSTRACT

Space usage benchmarking is provided among multiple institutions, such as academic institutions or schools. The space usage information is obtained relating to usage of space by each of plural participating institutions. The space usage information is obtained as data output from scheduling databases of the participating institutions. A space usage benchmark is formed automatically from the space usage information. The space usage benchmark is then provided to a selected participating institution with a comparison of the space usage benchmark to the space usage of that selected participating institution.

### TECHNICAL FIELD

The present invention relates to space usage benchmarking among institutions and, in particular, to space usage benchmarking based upon space usage information provided from scheduling databases of the institutions.

### BACKGROUND AND SUMMARY OF THE INVENTION

Management of space facilities is complex and expensive for many institutions, including educational institutions, and particularly post-secondary educational institutions. In the case of educational institutions, spaces may have various uses and adaptations, such as classrooms, conference rooms, lecture halls, laboratories for various technical fields, etc. As part of the management of such facilities, many educational institutions use scheduling software that, among other things, schedules the use of such spaces. This type of scheduling software is available from the assignee of the present invention as R25 and Schedule25™ software products, for example, and is also available from other software producers.

But many institutions, including educational institutions, are under pressure to reduce costs. One way in which costs can be reduced is to increase the efficiency of space usage. For example, by more efficiently using the space available, an educational institution like a university can reduce the need to build new classrooms and can reduce the costs associated with heating, cooling and maintaining space.

One way that institutions measure the efficiency of their space usage is by benchmarking. Benchmarking is a process of making performance comparisons of organizational processes against an internal or external standard. In the case of space usage benchmarking among plural institutions according to the present invention, the standards are external and are based upon the combined or amalgamated space usage performance of corresponding institutions.

Conventionally, space usage benchmarking for post-secondary educational institutions is based upon a survey that is either mailed out or electronically presented by an industry group asking member institutions specific questions about space usage. As one example, the Society of College and University Planning conducts one such survey. The surveys are completed manually at each institution based upon information obtained from a space usage database in response to many separate database queries entered by an institution worker. The space usage database is provided by the scheduling software, but the information required for the benchmarking survey is obtained only through manual querying of the database. When they are eventually completed, the space usage benchmarking surveys are returned and the results are eventually correlated to provide space usage benchmarking results that are typically made available to the members.

The effort and scale of manually responding to and compiling such surveys means that several months are typically required to collect and correlate the information for a single benchmark. As a consequence, such benchmarks provide at best a stale, one-time measure of space usage at the participating institutions. Such benchmarks are incapable of providing a currentspace usage benchmark because the institutions cannot provide current space usage information.

Accordingly, the present invention provides space usage benchmarking among multiple institutions, such as academic institutions or schools. In one implementation, space usage information is obtained relating to usage of space by each of plural participating institutions. The space usage information is obtained as data output files from scheduling databases of the participating institutions. A space usage benchmark is formed from the space usage information with anonymous or pseudonymous identification of the participating institutions to maintain in confidence the specific information about each institution. The space usage benchmark is then provided to a selected participating institution with a comparison of the space usage benchmark to the space usage of that selected participating institution.

For example, the space usage information may be obtained by a space usage benchmarking aggregator that is separate from all of the participating institutions. The space usage benchmarking aggregator may be an application service provider that receives the data output files, forms the space usage benchmark and makes it available to the participating institutions. The space usage benchmarking aggregator may further convey a communication from the selected participating institution to a queried participating institution that is anonymously or pseudonymously included in the space usage benchmark without identifying the queried participating institution to the selected participating institution.

As another implementation, a model of the space usage of the selected participating institution may be automatically adapted with respect to the space usage benchmark. The automatic adapting may includes iteratively varying selected factors of the model of the space usage of the selected participating institution toward a preselected space usage result related to the benchmark.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is an illustration of an operating environment for providing space usage benchmarking among multiple institutions according to the present invention.

FIG. 2 is block diagram illustrating how academic institutions access benchmarking information.

FIG. 3 illustrates data table entities as one implementation of a space usage benchmarking data model according to the present invention.

FIG. 4 is a flow diagram of a software-implemented space usage benchmarking method for providing benchmarking among multiple institutions.

FIG. 5 is a block diagram of a space usage modeling system that automatically applies variations to model data representing space usage by an institution to achieve a selected performance target based upon benchmarking data.

### DETAILED DESCRIPTION OF THE PREFERRED EMBODIMENTS

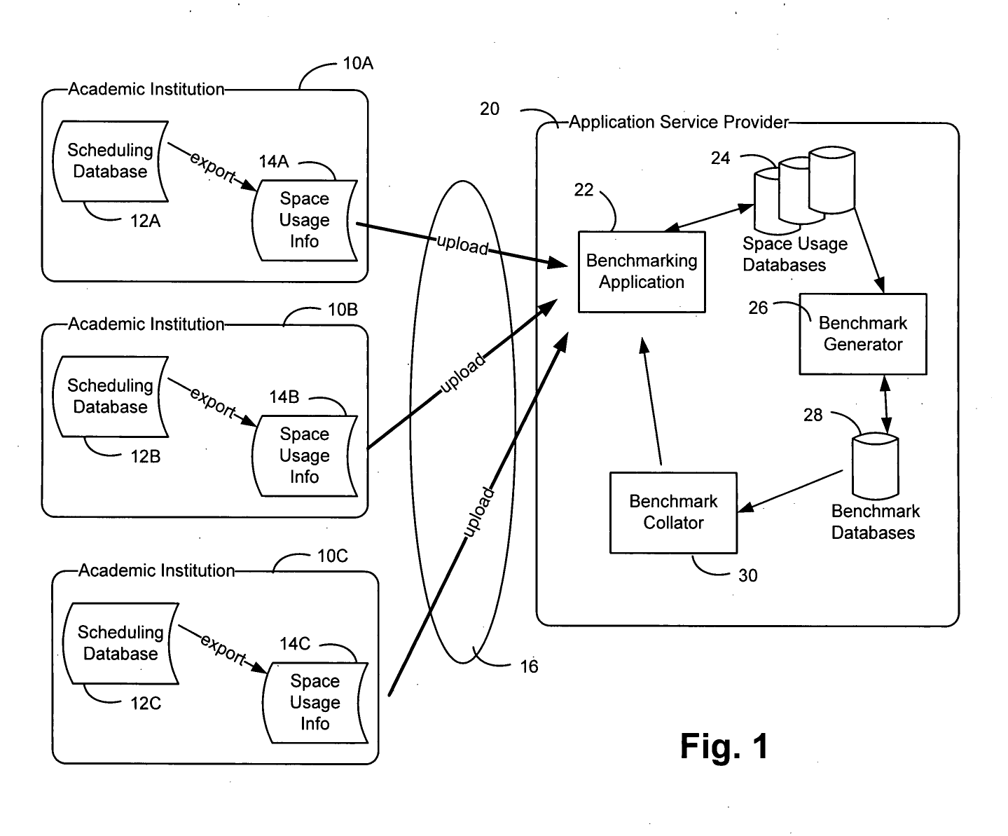

FIG. 1 is an illustration of an operating environment for providing space usage benchmarking among multiple institutions, such as academic institutions or schools. Benchmarking is a process of making performance comparisons of organizational processes against an internal or external standard. In the case of space usage benchmarking among plural institutions according to the present invention, the standards are external and are based upon the combined or amalgamated space usage performance of corresponding institutions. In one embodiment, the institutions are higher education institutions such as colleges or universities, and the space usage relates to the use of various rooms including classrooms, lecture halls, conference rooms, laboratories, etc.

With reference to FIG. 1, each of multiple academic institutions 10A-10C includes a corresponding scheduling record or database 12A-12C indicating current space usage by the institution according to scheduled academic activities (e.g., classes, lectures, conferences, laboratory exercises, athletic events, special events, maintenance, etc.). Scheduling databases 12A-12C are sometimes referred to individually or collectively as scheduling database 12 or scheduling databases 12.

For example, scheduling databases 12A-12C would include a proper or improper subset of information 14A-14C, respectively, relating to space usage. Space usage information 14A-14C, which is sometimes referred to individually or collectively as space usage information 14, indicates for each academic space in the institution (e.g., each classroom, lecture hall, conference room, laboratory, etc.) the times of scheduled classes, the number of students in each of the scheduled classes, and the maximum number of students who can use each space at one time (i.e., the student capacity of each academic space). In this context, the space usage information 14 represents merely a summation of available spaces, their types, the scheduled activities, and the numbers of participants. Accordingly, space usage information 14 typically includes a scheduling aspect and so may alternatively be referred to as scheduled usage information and may relate scheduled use of space or of other resources, such as equipment, personnel, etc.

As an example, a scheduling database 12 and space usage information 14 could be provided by R25™ academic and event scheduling software available from CollegeNET, Inc., the assignee of the present invention, or could be provided by other academic or facility scheduling software. It will be appreciated, therefore, that scheduling databases 12 would typically include fields of information in addition to the space usage information 14, but the space usage information 14 provides the basic information for space usage benchmarking among plural institutions according to the present invention.

Such academic and event scheduling software uses a model that describes the facilities that are available for scheduling, and then schedules events, such as courses, to the available rooms. For example, an institutional user specifies the courses that are to be taught at specified times throughout the day, and the scheduling program assigns the rooms, based upon the minimum room sizes and required amenities, such as white boards, video projection system, etc, that are required for each course. In a typical application, the institutional user creates a list of all the available classrooms, and the program schedules the courses into the classrooms. Users may also enter into the scheduling program other uses of spaces, including non-academic events, maintenance, etc. The scheduling program may also produce reports showing, for example, the percentage of time that a room of the institution is occupied or the percentage of the seats in the room that are occupied on the average.

Academic institutions 10A-10C deliver over a computer network 16 (e.g., the Internet) respective space usage information 14A-14C to an automatic space usage benchmarking application service provider (ASP) 20. The benchmarking ASP 20 operates automatically as a benchmarking aggregator in that the benchmarking operations are implemented by software executed on one or more computers rather than being implemented by a person or people manually compiling and processing the data.

A space usage benchmarking application 22 stores the received space usage information 14 in one or more databases or database files 24. For example, the usage information 14 from each institution is held in a separate database or database file 24 to preserve confidentiality of the information. A benchmark generator 26 extracts benchmarking information from the usage information 14 of the institutions and stores the benchmarking information in a benchmarking database 28.

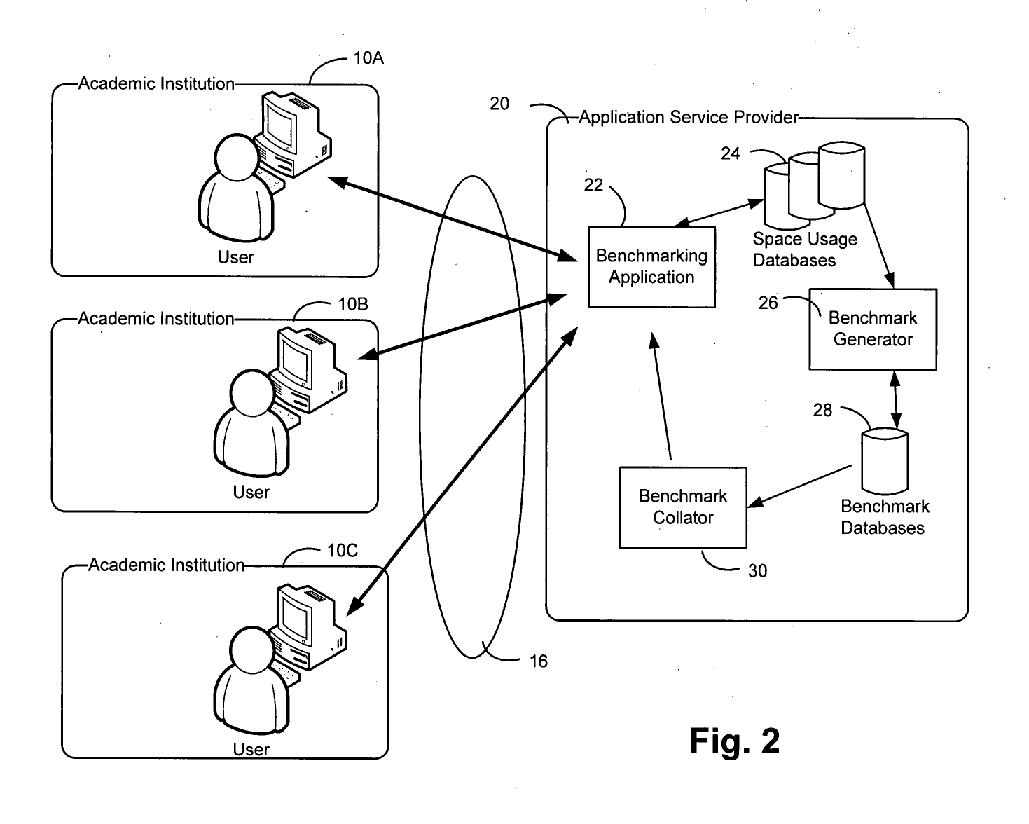

FIG. 2 is block diagram illustrating how academic institutions 10A-10C access the benchmarking information. Participating academic institutions 10A-10C, and possible other institutions, may access the benchmark information to measure or compare their individual space usage with the combined or amalgamated space usage of academic institutions 10A-10C or subsets of them.

The benchmarking application 22 receives from an institution 10 a request for a report of benchmarking information. The requesting institution may specify the benchmarking types or fields, the relevant benchmarking dates, the institution or institutions to be included in the benchmarking, etc. In one implementation, an institution 10 could request that the benchmarking information include only past data from that institution, thereby allowing the institution to identify trends or variations in its own history.

Benchmarking application 22 passes the received request to a benchmark collator 30 that functions to form a database query to retrieve the relevant benchmark information from benchmark database 28. Benchmark collator 30 receives the database query results and passes them to benchmark application 22, which forms a display of the results and provides the display to the requesting institution. The combined or amalgamated space usage in the benchmark database 28 includes either no identifying information for specific participating institutions or just pseudonymous identification of them. This maintains in confidence the space usage information from any particular institution. The pseudonymous identification of institutions allows them to be contacted without disclosure of their actual identity, as described below.

The space usage benchmarking among multiple institutions provided by the present invention contrasts with the sporadic and incomplete space usage benchmarking currently available to academic institutions. The space usage benchmarking currently available to academic institutions is based upon manual surveys. A benchmark is compiled from a survey delivered by an industry group asking members of the group about their space usage. The results are typically put into a table and made available to the members. Such manual benchmarking suffers from a severe lack of completeness or timeliness. Manual surveys are often incomplete due to the significant effort required to complete them for all spaces in an institution, and the significant effort can require several months for benchmarking data to be obtained and compiled.

The present invention provides benchmark information based upon space usage information 14 that is provided from an institution's database 12 indicating the current allocation of space. As a result, the benchmark information reflects space usage among institutions 10. Moreover, benchmark data 28 may be dynamically updated as institutions provide updated space usage information 14 or as additional institutions 10 provide space usage information 14.

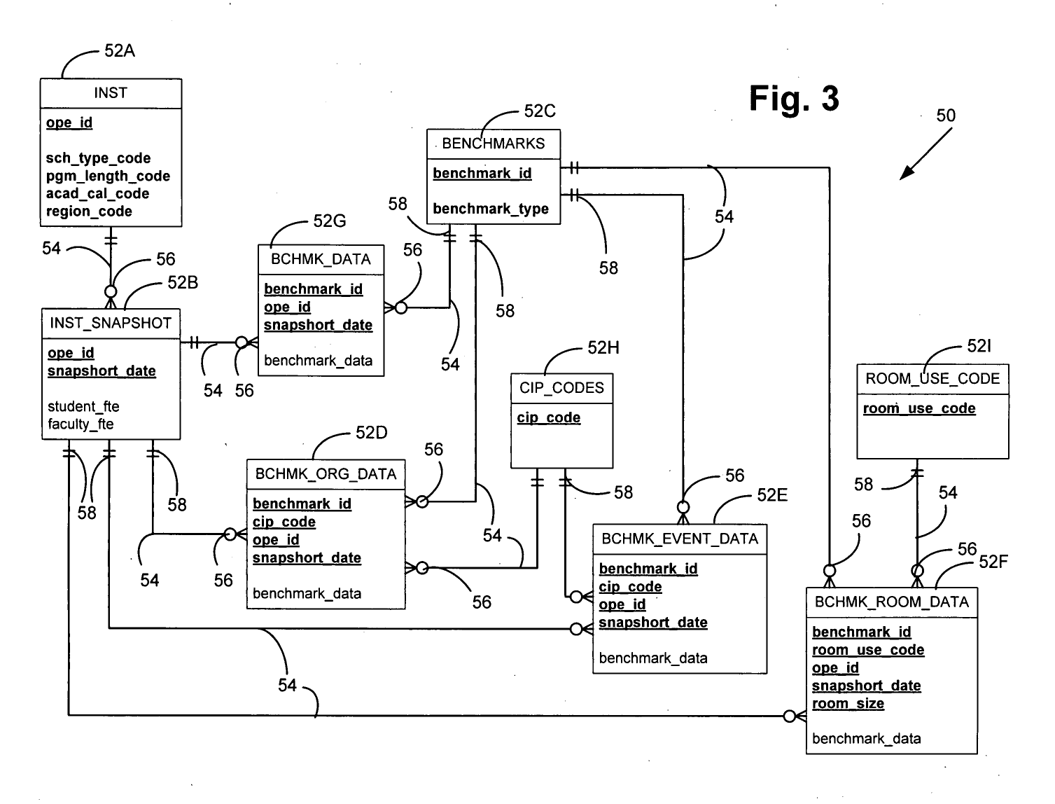

FIG. 3 illustrates data table entities as one implementation of a space usage benchmarking data model 50 according to the present invention. Data model 50 includes multiple data tables 52A-52I represented by boxes. Data tables 52A-52I are sometimes referred to individually or collectively as a data table 52 or data tables 52.

Each data table 52 includes one or more data fields that are listed by their names or indicators. A data field labeled in the drawing in text that is bold and underlined represents a primary key for that data table. Relationships 54 between data tables 52 are indicated by connecting lines. In the lines for relationships 54 each have two ends with different symbols. A multi-record symbol 56 has a small circle and three angled lines, and a single record symbol 58 has two parallel lines. Multi-record symbol 56 indicates that multiple records in the data table 52 where the multi-record symbol is positioned may correspond to a single record in the data table 52 with the single record symbol 58. For example, for each record in the INST data table 52A, there can be multiple records in the INST_SNAPSHOT table 52B.

An institution data table 52A, INST, lists the participating institutions, such as colleges or universities, that are providing space usage information to space usage benchmarking application service provider (ASP) 20 for benchmarking. The institution data table 52A includes a primary key data field, ope_id, which is a unique identifier for each participating institution. In the case of post-secondary academic institutions, the ope_id data field corresponds to the “OPE” code for the institution, the OPE code being an industry standard code issued by the Office of Postsecondary Education, an agency of the U.S. Department of Education, to uniquely identify institutions of higher education in the United States. Other database fields used in the institution table to describe characteristics of the institute include schedule type, program length, academic calendar, and region code. In one embodiment, these other database fields may correspond to standard fields established by, for example, the Office of Postsecondary Education.

An institution snapshot data table 52B, INST_SNAPSHOT, provides for each institution a “snapshot” of information captured at selected times. The institution snapshot data table 52B includes ope_id as a primary key data field to identify the institution that the snapshot relates to and a snapshot_date data field as another primary key to indicate the date on which the snapshot information was captured by the institution. The institution snapshot data table 52B also includes information about the institution as of the date of the snapshot, such as the number of students and the number of faculty. It will be appreciated that other data fields representing other information, such as preferred or planned improvements to be made to the spaces, projected tuition rates, faculty preferences, endowment and funding levels, etc., could also be included in the snapshot data table 52B.

In connection with space usage benchmarking, a benchmarks data table 52C, BENCHMARKS, lists an identifier benchmark_id for each instance of a benchmark in a benchmark collation, along with one of multiple types of benchmark indicated by the data field benchmark_type. For example, types of benchmark may include organizational benchmarks, event benchmarks, room benchmarks, and trend benchmarks, which may be further specified in an organization benchmark data table 52D, BCHMK_ORG_DATA, an event benchmark data table 52E, BCHMK_EVENT_DATA, or a room benchmark data table 52F, BCHMK_ROOM_DATA, respectively. It will be appreciated that organization benchmark data table 52D, event benchmark data table 52E, and room benchmark data table 52F are merely illustrative of one embodiment and that other types of benchmarks could be used in addition to or instead of the specified types, whether for academic institutions or others types of institutions.

Organization benchmark data table 52D, event benchmark data table 52E, room benchmark data table 52F, and a benchmark data data table 52G, BCHMK_DATA, each include benchmark_data corresponding to the respective benchmarking types. Event-type benchmarks break down benchmarking data by types of events, such as types of courses. For example, an event benchmark could include the seat utilization for undergraduate courses, the number of instructional hours for a particular subject, or the number of graduate and undergraduate courses, the class size by type of course. It is typically desirable to spread classes throughout the day. If classes are over too short a time period, students may have difficulty with conflicting course schedules, and room utilization may be low during off hours.

Organization-type benchmarks break down benchmarking data by types of organizations. Organization types in an academic institution include, for example, colleges or professional schools within a university, departments within colleges, non-academic organizational units within institutions, etc.

Room-type benchmarks break down benchmarking data by types of rooms. Room types within an academic institution include, for example, classrooms, auditoria, offices, laboratories, etc.

Organization benchmark data table 52D, event benchmark data table 52E, room benchmark data table 52F, and a benchmark data data table 52G, BCHMK_DATA each include data fields indicating a benchmark identifier benchmark_id, ope_id, and snapshot_date. As a result, each record in the benchmark data tables includes a benchmark ID to uniquely identify the data, an ope_id to identify the institution from which the data is derived, and the snapshot date to indicate which data was used to generate the benchmark data. In addition, organization benchmark data table 52D and event benchmark data table 52E each further include a cip_code data field, linked to a corresponding cip₁₃ code data field of a CIP codes data table 52H, CIP_CODES. “CIP” codes are industry standard codes for identifying college courses and subject areas. CIP codes data table 52H lists all the standard codes that are available for use. The room benchmark data table 52F also includes a room_size_code data field and and a room_use_code date field, which correspond to industry-standard room use codes that are stored in a room_use code data table 52I.

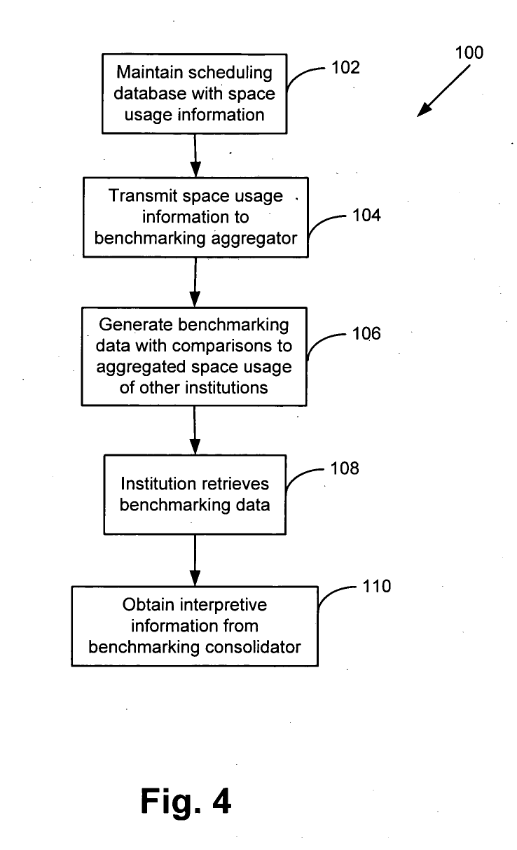

FIG. 4 is a flow diagram of a software-implemented space usage benchmarking method 100 for providing benchmarking among multiple institutions, such as academic institutions.

In step 102, each of multiple participating institutions maintains a scheduling database that includes space usage information. The space usage represents merely a summation of available spaces, their types, the scheduled activities, and the numbers of participants (i.e., students).

In step 104, each participating institution transmits its space usage information from its scheduling database to a space usage benchmarking aggregator. In one embodiment, the space usage benchmarking aggregator may be an application service provider that is independent of each of the participating institutions. It will be appreciated, however, that the space usage benchmarking aggregator could alternatively be one or more of the participating institutions or an organization with which the participating institutions is associated, such as a regional academic conference or a state board of higher education.

In step 106, the space usage benchmarking aggregator extracts from the space usage information and generates benchmarking data that provides for each institution a comparison between its space usage and the consolidated space usage of plural other institutions. The space usage benchmarking can relate to any of an arbitrary number of space usage metrics such as, for example, the percentage of time that rooms are in use and the average percentage of seats that are in use in each room, for different types of rooms and for institutions having different characteristics. The space usage benchmarking can indicate just the cumulative or amalgamated results for all or a subset of multiple participating institutions, either as absolute numeric measures or as relative percentages. For example, subsets of institutions could be specified as certain types, such as Ivy League schools, state universities, small liberal arts colleges, etc. It will be appreciated that these are merely examples of the types and formats of the space usage benchmarking that can be provided by method 100 and that the space usage benchmarking can be provided as many other types and in may other formats.

In step 108, a participating institution retrieves benchmarking data that is an aggregation or amalgamation of space usage results for all or a subset of the participating institutions. The benchmarking data is retrieved from the space usage benchmarking aggregator and may, or may not, include a comparison between the space usage of the retrieving institution and the consolidated space usage of other institutions. The space usage benchmarking can indicate the consolidated or amalgamated results for all or a subset of the participating institutions, either as absolute numeric measures of space usage (e.g., hours of usage per classroom) or as relative percentages or as ratios.

In step 110, the participating institution that retrieves benchmarking data obtains from the space usage benchmarking aggregator interpretive information for interpreting the comparison between the space usage of the retrieving institution and the consolidated space usage of other institutions. The interpretive information may be obtained, for example, as a query that is directed to a pseudonymous participating institution via the space usage benchmarking aggregator, which knows the identity of the pseudonymous participating institution and forwards the query thereto.

The query may request an explanation of how or why the pseudonymous participating institution achieves space usage performance different from that of the querying institution. Such communications allow the pseudonymous participating institution to maintain its anonymity and the confidentiality of its information while also supporting the sharing of analytical information and expertise between institutions. As another example, the interpretive information may be obtained from a store of past such communications, in the form of a record of Frequently Asked Questions or “FAQs”, that are stored and maintained by benchmarking aggregator and can be accessed by participating institutions.

It will be appreciated that the present invention can provide a time dimension to space usage analyses, as opposed to the sporadic, single snapshot approach of prior manual benchmarking. Periodic updating of the space usage information from participating institutions allows compilation of static, time-specific benchmarks, and allows for determination of dynamic benchmarking trends. As a result, an institution can strive to achieve benchmarking targets that reflect projected group-wide usage, rather than striving to achieve performance standards that are stale and inaccurate.

As another embodiment, dynamic benchmarking allows a participating institution to set notification criteria to receive a communication (e.g., via e-mail, telephone, etc.) automatically whenever the performance of the institution exceeds a level of benchmark performance. For example, a participating institution may choose to be automatically notified if its overall utilization falls below a selected metric. As examples, the selected metric could be a new group-wide average, the 75th percentile of comparable institutions, or the 50th percentile of more prestigious institutions. The notification criteria may be triggered by changes in the performance of the participating institution setting the criteria or by changes in the aggregated data from the benchmarking institutions.

In an alternative embodiment, space usage of an institution and variations of the space usage may be modeled and compared to the benchmarking data automatically. Beginning with a model of an institution's existing space usage, the effect of specified usage changes are automatically modeled or determined and compared with the benchmarking data. This can allow an institution to determine what space usage changes are required to achieve a particular space usage result.

For example, a participating institution such as a small liberal arts college could determine how possible changes in its space usage would affect its space usage performance relative to the benchmarks of other similar colleges. Conventionally, the institution would decide upon a surrogate performance target and would manually alter input variables (e.g., the numbers and sizes of different types of rooms or changes in enrollment) into the academic and event scheduling software and run the resulting model against a schedule of events to determine space usage performance. Such manual modeling can be tedious and result in haphazard analysis of variations. In contrast, an embodiment of the present invention automatically models variations of the space usage of an institution against benchmarking data to achieve a more thorough modeling of space variations. This can improve space planning with regard to facilities costs, enrollment variations, faculty load changes, and facilities costs.

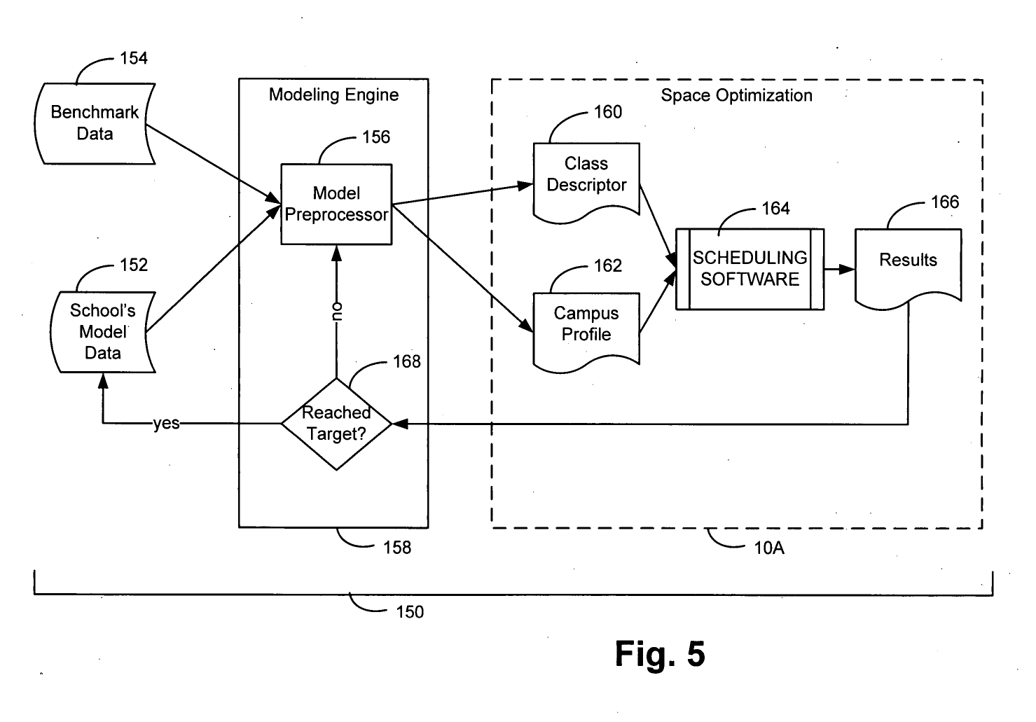

FIG. 5 is a block diagram of a space usage modeling system 150 that automatically applies variations to model data 154 representing space usage by an institution to achieve a selected performance target based upon benchmarking data 152 provided by method 100 (FIG. 4). Beginning with the current space usage, modeling system 150 varies the underlying factors or variables in the space usage model data 152, such as time, class size, numbers of classes, available space, appropriateness of the space, etc., according to heuristic algorithms. Such a system is preferable to the extreme complexity and redundant analysis of modeling space usage from scratch without reference to the current space usage.

A model pre-processor 156 of an automatic space usage modeling analysis engine 158 functions to automatically and iteratively vary the underlying factors or variables in the space usage model data 152. In operation model pre-processor 156 applies the variations in the underlying factors in the space usage model data 152 as class descriptor data 160 that describe class schedules and campus profile data 162 that describe institutional facilities and organizational capacities and constraints. The class descriptor data 160 and campus profile data 162 are delivered as inputs into academic and event scheduling software 164. Based upon the class descriptor data 160 and campus profile data 162, scheduling software 164 determines classroom assignments in a conventional manner. In addition, the scheduling software 164 also analyzes the classroom schedule to produce results 166 with space usage information indicating, for example, room assignments and seat utilization.

The results 166 are returned to space usage modeling analysis engine 158 for a comparison 168 of whether the results 166 indicate that that benchmark-based target is achieved. If the comparison 168 indicates that the results 166 show output parameters that meet specified criteria derived from the benchmark data 154, then the space usage data 152 that provided the results 166 are returned as having met the benchmark-based target.

Alternatively, the comparison 168 may indicate that the results 166 show output parameters that do not meet specified criteria derived from the benchmark file 154. For example, the results 166 may show that the seat utilization is significantly below that of a class of institutions specified by the user. As a result, preprocessor 156 alters at least one of the class descriptor data 160 and campus profile data 162 and delivers the new data to scheduling software 164. For example, preprocessor 156 could vary just a class descriptor data 160 by splitting a large classroom into two small classrooms.

In determining recommended changes, automatic modeling system 150 places a weighting value on various inputs and outputs. For example, it may consider the output variable that corresponds to the even distribution of classes throughout the day to be more important than the output variable of seat utilization in some types of classrooms. Automatic modeling system 150 may also be biased to altering certain input variables are more readily than other input variables. For example, a user can set a bias such that the number of classrooms of a first type, such as small classrooms without audio-visual equipment, can be increased more readily than classrooms of a second type, such as, chemistry labs that require special ventilation and fireproofing. As another example, spreading times more evenly throughout the week may place courses at inconvenient times, so a school may want to place a relative weight on the time spread in relation to the convenience of the course schedule.

Automatic modeling system 150 can vary the input parameters and evaluate whether the output is an acceptable schedule. The weighting can also be determined in part by the benchmarking data 154. For example, one type of institution may place a higher value on seat utilization than another type of institution.

The weighting of the input and output variables is preferably determined individually by the institution using the model. This allows the model to reflect the different values that different institutions place on the input and output variables. Alternatively, different sets of weighting can be used for different types of institutions, or a common weighting can be used for all institutions, or different sets of weighting can be used for different types of institutions.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments described in the specification. As one of ordinary skill in the art will readily appreciate from the disclosure of the present invention, presently existing or later-developed variations that perform substantially the same function or achieve substantially the same result as the corresponding embodiments described herein may be utilized according to the present invention. Accordingly, the invention is claimed as follows.

1. A space usage benchmarking method, comprising:
obtaining space usage information relating to usage of space by each of plural participating institutions as data obtained directly from scheduling databases of the participating institutions;
automatically forming from the space usage information a space usage benchmark; and
providing the space usage benchmark to a selected participating institution over a computer network with a comparison of the space usage of the selected participating institution with the space usage benchmark.

2. The method of claim 1 in which each participating institution is an educational institution.

3. The method of claim 2 in which each participating institution is a post-secondary educational institution.

4. The method of claim 1 in which the space usage information is obtained by a space usage benchmarking aggregator that is separate from all of the participating institutions.

5. The method of claim 4 in which space usage benchmarking aggregator is an application service provider.

6. The method of claim 1 further comprising providing communication from the selected participating institution to a queried participating institution that is anonymously or pseudonymously included in the space usage benchmark without identifying the queried participating institution to the selected participating institution.

7. The method of claim 1 further comprising automatically adapting a model of the space usage of the selected participating institution with respect to the space usage benchmark.

8. The method of claim 7 in which the adapting includes iteratively varying selected factors of the model of the space usage of the selected participating institution toward a preselected space usage result.

9. The method of claim 1 in which providing the space usage benchmark to the selected participating institution includes the selected participating institution selecting one or more fields of information to be included in the space usage benchmark.

10. The method of claim 9 in which the selected participating institution selects a class of one or more institutions to be included in the space usage benchmark.

11. The method of claim 9 in which the selected participating institution selects that the space usage benchmark include only space usage information from the selected participating institution.

12. The method of claim 1 further comprising providing the selected participating institution a communication automatically whenever a selected performance of the selected participating institution exceeds a level of benchmark performance.

13. In a computer-readable medium, space usage benchmarking software, comprising:
software for obtaining space usage information relating to usage of space by each of plural participating institutions as data output obtained directly from scheduling databases of the participating institutions;
software for automatically forming from the space usage information a space usage benchmark; and
software for providing the space usage benchmark to a selected participating institution with a comparison of the space usage of the selected participating institution with the space usage benchmark.

14. The medium of claim 13 in which each participating institutional is an educational institution.

15. The medium of claim 13 in which the space usage information is obtained by a space usage benchmarking aggregator that is separate from all of the participating institutions.

16. The medium of claim 13 further comprising software for providing communication from the selected participating institution to a queried participating institution that is anonymously or pseudonymously included in the space usage benchmark without identifying the queried participating institution to the selected participating institution.

17. The medium of claim 13 further comprising software for automatically adapting a model of the space usage of the selected participating institution with respect to the space usage benchmark.

18. A space usage benchmarking method, comprising:
providing space usage information relating to usage of space by a participating institution as data output provided directly from a scheduling database of the participating institution; and
obtaining a space usage benchmark formed from space usage information provided by plural participating institutions, the space usage benchmark being obtained by a selected participating institution with a comparison of the space usage of the selected participating institution with the space usage benchmark.

20. The method of claim 19 in which each participating institutional is an educational institution.

21. The method of claim 19 in which the space usage information is obtained by a space usage benchmarking aggregator that is separate from all of the participating institutions.

22. The method of claim 21 in which space usage benchmarking aggregator is an application service provider and in which the data output files are transmitted by each of the participating institutions to the application service provider over a computer network.

23. The method of claim 19 further comprising providing communication from the selected participating institution to a queried participating institution that is anonymously or pseudonymously included in the space usage benchmark without identifying the queried participating institution to the selected participating institution.

24. The method of claim 19 further comprising automatically adapting a model of the space usage of the selected participating institution with respect to the space usage benchmark.

25. The method of claim 24 in which the adapting includes iteratively varying selected factors of the model of the space usage of the selected participating institution toward a preselected space usage result.
